(19) United States
(12) Patent Application Publication
(10) Pub. No.: US 2025/0111307 A1
(43) Pub. Date: Apr. 3, 2025

(54) MANAGING COMPUTING RESOURCES DURING MERGERS AND ACQUISITIONS

(71) Applicant: VMware LLC, Palo Alto, CA (US)

(72) Inventors: Igor Grubisic, Long Island City, NY (US); Barbara Maria Eder, Aurora (CA); Paul Gentile, Jamesburg, NJ (US)

(21) Appl. No.: 18/477,846

(22) Filed: Sep. 29, 2023

(51) Int. Cl. G06Q 10/0631

(52) U.S. Cl. CPC G06Q 10/06312; G06Q 10/06315

(57) ABSTRACT

Described herein are systems, methods, and software to manage applications, databases, data centers, and personnel during mergers and acquisitions. In one implementation, a management service migrates one or more applications from one or more data centers associated with a first company to one or more data centers associated with a second acquiring company. The management service further monitors resource usage associated with the one or more applications and determines a configuration for deploying the one or more applications based on the resource usage. The configuration defines at least execution locations in a set of data centers for the second company.

### BACKGROUND

Mergers and acquisitions (M&A) comprise corporate activities involving the combination of two or more companies or organizations. In a merger, two separate companies agree to join (or merge) and become a single entity, typically with shared ownership and management. Mergers are often used to provide synergy, where the combined entity can benefit from cost savings, increased market share, and improved competitiveness. Mergers can take various forms, such as horizontal mergers (between companies in the same industry), vertical mergers (between companies in different stages of the supply chain), or conglomerate mergers (between unrelated companies).

Alternatively, acquisitions involve one company purchasing another, often resulting in the acquired company becoming a subsidiary of the acquiring entity. Acquisitions are typically driven by a desire to gain access to new markets, technologies, talent, or resources. They can also be a means to eliminate competition or diversify a company's product or service portfolio. Successful M&A transactions require careful due diligence, integration planning, and consideration of financial, strategic, and cultural factors to ensure that the intended benefits are realized.

In some implementations, the M&A can introduce new computing resources from one of the entities involved in the M&A. For example, a first company acquiring a second company will inherit the various data centers, applications, virtual machines, and databases of the second company. However, difficulties can arise in managing the security of the resources associated with the second company during the merger and efficiently and effectively incorporating the resources into the existing resources associated with the first company. Additional difficulties also result in merging the human resources or employees from the acquired company into the acquiring company.

OVERVIEW

The technology disclosed herein manages the deployment of resources during mergers and acquisitions of companies. In one implementation, a method includes migrating and merging one or more applications from one or more first data centers associated with a first company to one or more second data centers associated with a second company and monitoring resource usage associated with the one or more applications in the one or more second data centers. The method further comprises determining a configuration for the one or more applications based on the resource usage associated with the one or more applications and applying the configuration, wherein the configuration defines at least execution locations in a set of data centers for the second company.

In some implementations, the configuration is further determined based on power target goals in association with the one or more applications, or application preferences associated with the second company, wherein the application preferences comprise application vendors, application types, or application versions.

### BRIEF DESCRIPTION OF THE DRAWINGS

FIGS. 1A-1B illustrates a computing environment to manage an acquisition of application and database resources of an organization according to an implementation.

FIG. 2 illustrates an operation of a management service to manage applications and databases from an acquired organization according to an implementation.

FIG. 3 illustrates an operational scenario of managing the deployment of applications and databases from an acquired organization according to an implementation.

FIG. 4 illustrates a computing environment to manage remote desktop availability for acquired personnel according to an implementation.

FIG. 5 illustrates an operation of a management service to manage application allocations to acquired personnel according to an implementation.

FIG. 6 illustrates an operational scenario of defining applications for a user group according to an implementation.

FIG. 7 illustrates a computing system to manage resources associated with a merger or acquisition according to an implementation.

### DETAILED DESCRIPTION

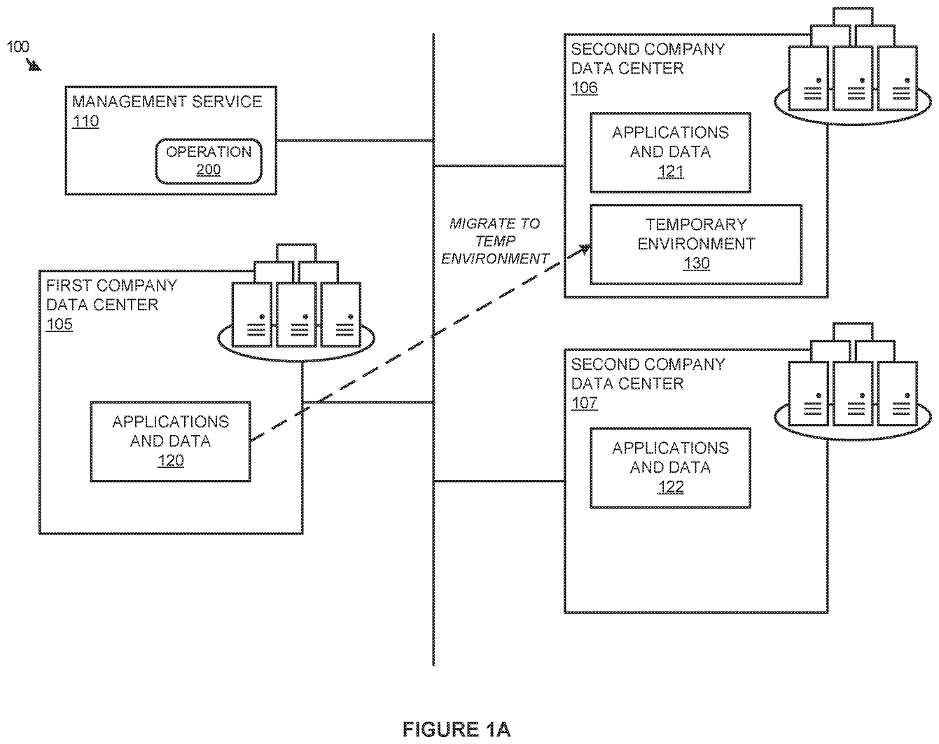

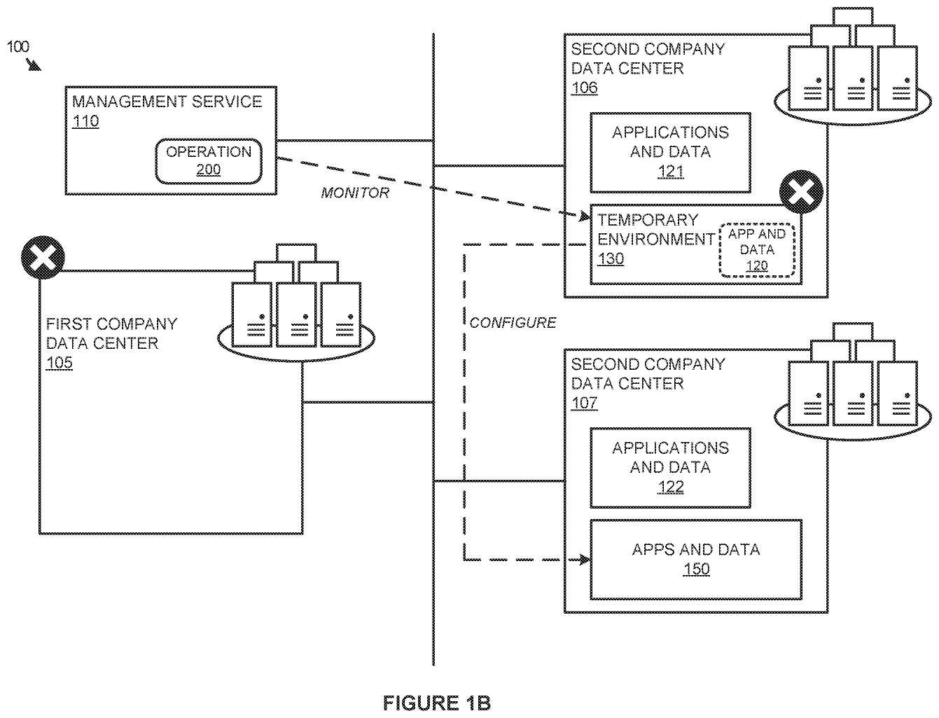

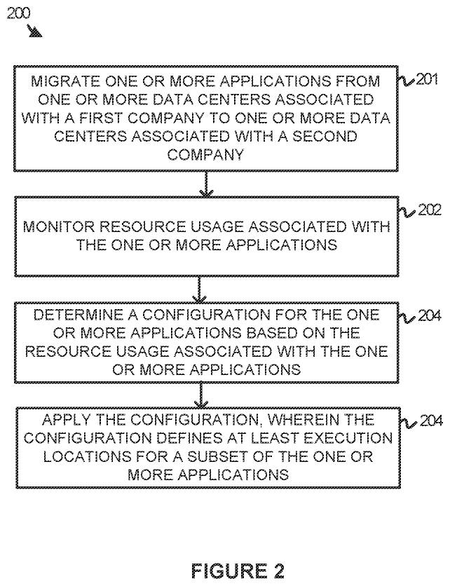

FIGS. 1A-1B illustrates a computing environment 100 to manage an acquisition of application and database resources of an organization according to an implementation. Computing environment 100 includes management service 110, first company data center 105, and second company data centers 106-107. First company data center 105 further includes applications and data 120, second company data center 106 further includes applications and data 121 and temporary environment 130, and second company data center 107 further includes applications and data 122. Management service 110 provides operation 200 that is further described below with respect to FIG. 2. Management service 110 can be supported via one or more computing systems and, while demonstrated separate from second company data centers 106-107, can be implemented at least partially on the computers in the data centers.

Referring first to FIG. 1A, the second company acquires the first company, including first company data center 105 and applications and data 120. An acquisition refers to the process in which a company (i.e., the second company in FIG. 1A) purchases another company, often through the exchange of cash, stock, or a combination of both. The acquiring company, also known as the buyer or acquirer, gains control over the acquired company's assets (including data centers and all digital assets), operations, and often its brand and workforce. Acquisitions are typically pursued to achieve strategic goals such as expanding market share, accessing new technologies, entering new markets, or achieving synergies that can lead to increased profitability and competitive advantage.

Here, after the acquisition of the first company and first company data center 105, management service 110, which is employed by the second company, migrates applications and data 120 from first company data center 105 to second company data center 106. Applications and data 120 comprise the software programs and services that are hosted via the data center to provide various operations of the company. The operations can include web hosting, database management, virtualization, data analytics, or some other software. Applications and data 120 further represent any database supported by the first company, wherein the databases can comprise an SQL database, NoSQL database, or some other database for the company. In migrating applications and data 120 from first company data center 105 to second company data center 106, management service 110 provides physical resources at second company data center 106 to support the execution of the applications and the storage of the databases. The resources comprise physical computers, such as servers, that provide the required processing, memory, storage, networking, and the like for applications and data 120. In some implementations, second company data center 106 provides different security measures than first company data center 105. The different security measures can include different firewall configurations, personnel access, computer software, or other security parameters than first company data center 105. Advantageously, management service 110 migrates applications and data 120 to temporary environment 130 to enable required security parameters associated with the second company.

Turning to FIG. 1B, after the migration of applications and data 120, management service 110 monitors resource usage and other factors associated with applications and data 120 to determine a configuration for the applications and data in the infrastructure of the second company. The other factors may include power targets associated with the second company, such as quantity of required data centers, quantity of servers, and the like, can include application preferences associated with the second company, can comprise carbon footprint concerns, or can comprise some other factor. For example, an administrator associated with the second company provides target goals for the number of data centers to be employed by the second company. From the monitored resource usage and the preferences provided by the second company, management service 110 determines a configuration for applications and data 120. The configuration comprises at least execution locations for the applications, data storage for the databases and data, or some other configuration information. In some implementations, management service 110 selects one or more data centers from the available data centers for applications and data 120. In the example of computing environment 100, management service 110 selects second company data center 107 to support the execution of at least a portion of applications and data 120 as applications and data 150.

In some implementations, in determining the configuration for applications and data 120, management service 110 determines applications that can be terminated from applications and data 120. Specifically, during the execution in temporary environment 130, management service 110 identifies applications that are being unused in the new environment, applications that provide the same service as other applications of applications and data 121-122, or some other determination in association with the application no longer being required. Accordingly, when applications and data 150 are deployed from applications and data 120, management service 110 can terminate any of the identified applications, limiting the resource usage of the unused or duplicated applications for the second company.

After applications and data 150 are moved to second company data center 107, management service 110 initiates operations to terminate unused resources in the environment. The operations can include stopping one or more servers, entire data centers, or some other action. Here, management service 110 terminates or initiates the termination of first company data center 105 as the resources are no longer required to support the applications and data for the second company.

FIG. 2 illustrates an operation 200 of a management service to manage applications and databases from an acquired organization according to an implementation. The steps of operation 200 are referenced parenthetically in the paragraphs that follow with reference to systems and elements of computing environment 100 of FIGS. 1A-1B.

For operation 200, management service 110 migrates (201) one or more applications from one or more data centers for a first company to a temporary environment supported by one or more data centers for a second company. The migration occurs in response to an acquisition of the first company by the second company, permitting the second company to control the applications and data associated with the first company. In migrating the applications, management service 110 transfers the required software and data from the first data centers to the second data centers, permitting the applications to execute and make the required data available (e.g., databases) in the data centers for the second company. The data centers for the second company include compliance standards and security required by the second company, and may further comprise different hardware (servers, processors, and the like) that is preferred by the second company over the first company.

After the one or more applications are migrated to the one or more data centers of the second company, operation 200 further monitors (202) at least resource usage associated with the one or more applications. The resource usage can comprise processing resource usage, power usage, carbon footprint, memory resource usage, networking requirements, or some other resource usage associated with the different applications. In some implementations, management service 110 further identifies application preferences associated with the second company. For example, an administrator associated with the second company can provide desired vendors for applications, desired application types, and/or desired application versions. In some implementations, management service 110 further obtains power target goals or cost goals associated with operating the applications inherited from the first company. For example, management service 110 receives an indication that the applications inherited from the first company should prioritize power efficiency over processing power.

From the monitored or obtained information about the one or more applications during the temporary deployment in the one or more data centers for the second company, operation 200 further determines (203) a configuration for the one or more applications based at least on the resource usage associated the one or more applications. Once determined, operation 200 applies (204) the configuration, wherein the configuration defines at least execution locations in a set of data centers for the second company. In some implementations, the set of data centers for permanent deployment of the applications is different from the one or more data centers during the temporary deployment. In some examples, the permanent deployment and the temporary deployment can share at least one common data center.

In some implementations, in determining the configuration, management service 110 will compare the resource usage of the various applications and identify a data center that best supports or can provide the resources required for the applications. For example, management service 110 will determine that a first application requires a first set of resources, while a second application requires a second set of resources. Accordingly, management service 110 allocates the first application to a first data center and the second application to a second data center, wherein the two data centers provide different resources (e.g., server type, processor type, and the like).

In some implementations, management service 110 will determine whether one or more applications should be incorporated into existing applications of the second company or whether the application is required by the second company. For example, management service 110 compares the applications in applications and data 120 to preferences provided by an administrator to determine whether any applications should be terminated. If an application is to be terminated, management service 110 prevents the application from being deployed in applications and data 150 at second company data center 107. Additionally, when an application for the first company is merged into a second application of the second company, management service 110 can migrate and manage the data from the application into the second application (e.g., migrate database or other information).

Although described in the example of FIG. 2 using the example of applications, management service 110 performs similar operations in associations with databases associated with the first company. For example, management service 110 migrates a database from first company data center 105 to second company data center 106 and monitors database requirements associated with the database. The database requirements can comprise storage requirements, frequency of access to the database, or some other monitored characteristics. In some examples, management service 110 obtains at least a portion of the database requirements from an administrator associated with the second company. The requirements can comprise versioning information for the database, database type information, or some other information. For example, management service 110 obtains version requirements associated with a database migrated to temporary environment 130, wherein the current version in temporary environment 130 is different than the required version. In determining the database configuration that moves the database out of temporary environment 130, management service 110 updates the version of the database to support the required version provided as a preference. In other examples, management service 110 integrates a database with an existing database for the second company, deletes unnecessary databases, or provides some other operation based on the provided preferences. Management service 110 can also consider the storage requirements, access time requirements, or other operational requirements of a database in selecting the data center for the database following the monitored period in temporary environment 130.

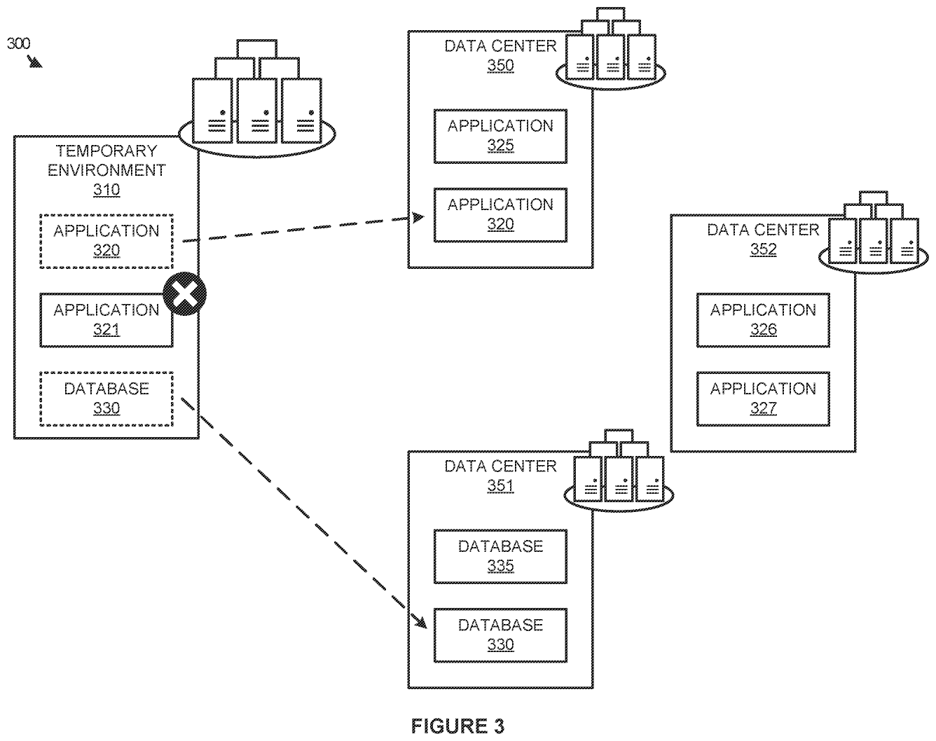

FIG. 3 illustrates an operational scenario 300 of managing the deployment of applications and databases from an acquired organization according to an implementation. Operational scenario 300 includes temporary environment 310, and data centers 350-352. Temporary environment 310 includes applications 320-321 and database 330. Data centers 350-352 further include applications 325-327 and database 335.

In operational scenario 300, applications 320-321 and database 330 are migrated by a management service to temporary environment 310. In migrating applications 320-321 and database 330, management service transfers the data and applications from one or more first data centers associated with a first company to temporary environment 310 that comprises one or more data centers of a second company. Temporary environment 310 maintains security requirements associated with the second company, wherein the security requirements can comprise access control, networking management, physical security, power redundancy, or some other security requirement associated with the second company. For example, if applications 320-321 represent web applications, temporary environment 310 provides the required security and physical resources to support the execution of the web applications. The physical resources can comprise servers, networking, or some other physical resource to provide the functionality of the applications.

After applications 320-321 and database 330 are migrated to temporary environment 310, the management service monitors resource usage associated with applications 320-321. The resource usage can comprise processing resource usage, memory resource usage, or some other resource usage. Additionally, in some implementations, the management service considers preferences associated with the second company, including application preferences, power usage preferences, and the like. The preferences can be provided via one or more administrators associated with the second company. The application preferences comprise application vendor, application version, or application types. The power usage preferences comprise prioritization preferences, including prioritizing efficiency over processing power, or prioritizing smaller quantities of data centers over processing power. From the resource usage and the preferences provided by an administrator, the management service generates a configuration for applications 320-321 and database 330. The configuration defines at least the execution locations (if any) for the applications and a database location for database 330. Specifically, the management service moves application 320 from temporary environment 310 to data center 350 and migrates database 330 from temporary environment 310 to data center 351. In migrating the application and the database, the management service can change the version of the application or database, change the type of database, or provide some other configuration change based on the preferences of the second company. Data centers 350-352 are each representative of a data center controlled by the acquiring company, permitting the acquiring company to maintain security requirements in association with the data for application 320 and database 330.

As further illustrated in operational scenario 300, the management service terminates application 321. The management service terminates the application based on the application preferences provided by the administrator or the power targets associated with the deployment of the application. For example, an administrator provides application preferences that indicate approved application vendors for applications deployed by the acquiring company. When application 321 does not satisfy the vendor requirements of the acquiring company, application 321 will not be migrated to a destination data center for execution.

Although demonstrated in FIG. 3 as moving applications and databases from temporary environment 310 to other data centers 350-352, temporary environment 310 can be located wholly or partially in data centers 350-352. Alternatively, temporary environment 310 can be in a separate data center separate from data centers 350-352.

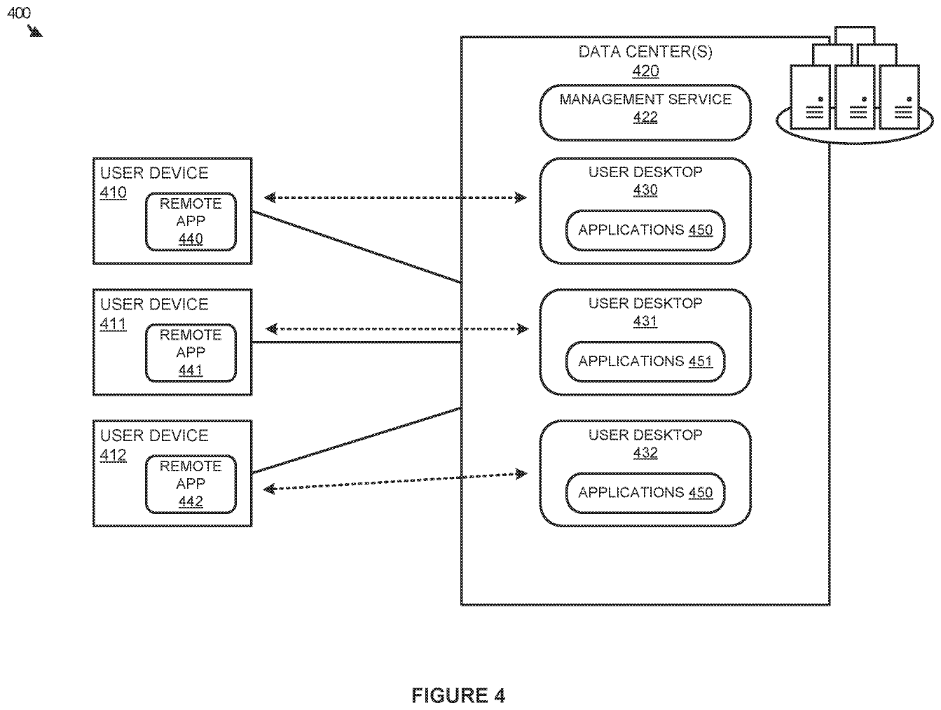

FIG. 4 illustrates a computing environment 400 to manage remote desktop availability for acquired personnel according to an implementation. Computing environment 400 includes user devices 410-412 and data center(s) 420. User devices 410-412 further include remote applications 440-442 that are used to access user desktops 430-432. User desktops can comprise virtual machines or virtual desktops capable of supporting applications 450-451 for the users of user devices 410-412. The applications can comprise email applications, word processing applications, code development applications, database applications, or some other application. Data center(s) 420 further comprise management service 422 that can manage access permissions to the different user desktops 430-432 and allocate applications to the different user desktops.

In computing environment 100, data center(s) 420 execute user desktops 430-432, wherein user desktops 430-432 are isolated from each other, enabling users to switch between them as if they were distinct physical machines, even though they share the same underlying hardware resources. User desktops 430-432 are representative of virtual desktops that enhance resource utilization, security, and flexibility in various computing scenarios, such as remote work, software testing, and centralized management of desktop environments in enterprise settings.

Here, user devices 410-412 are representative of user devices for employees of an acquired company. To provide the required applications associated with the acquiring company, the acquiring company can manage user desktops 430 in data center(s) 420. To access the virtual desktops, each user of user devices 410-412 can provide credentials to remote application 440 that in turn provides the user with a corresponding user desktop of user desktops 430-432. For example, when a user of user device 410 provides credentials (e.g., username, password, etc.) to remote application 440, user desktop 430 is identified to support the request and a connection is made to display user desktop 430 at user device 410 using remote application 440.

In selecting the applications for each of the users, management service 422 is provided. Management service 422 identifies different user types associated with the acquired company and identifies applications and access privileges required for each of the user types from the acquired company. Additionally, management service 422 identifies applications for the users from the acquiring company and removes applications that provide the same functionality or are no longer permitted by the acquiring company. For example, a legal user from the acquired company uses a first email application, but the acquiring company uses a different email application. When the application set is generated for the legal users, management service 422 selects the acquiring company's application and adds it to the available applications for the user. In other examples, management service 422 removes applications that are no longer required by the acquiring company, removes applications with licensing issues, maintains applications from the acquired company that are not replaceable by the acquiring company, or provides some other operation to select the applications for the different user types. Once the applications are selected for the different user types, management service 422 can assign users to the corresponding user desktop. By managing the applications remotely, the acquiring company provides a secure virtual environment that limits permissions and access to various applications. Advantageously, the acquiring company can maintain security in association with the acquired applications and the previously controlled applications.

In some implementations, each user desktop 430 comprises the installed applications that are directly installed and capable of storing the necessary user data for each of the users. In other implementations, the user desktops can be created as needed. For example, when user device 410 initiates a request for a virtual desktop, management service 422 will identify the applications and access privileges that are required for the user (and any additional data, including security certificates) and attach the applications and data to the virtual machine. The attachment process includes mounting one or more volumes to the virtual machine to make the applications executable for the user and any required data available to the user. Advantageously, a single desktop can support different types of users by attaching the required applications as needed to support the user requirements. Thus, while user desktop 430 provides applications 450 to user device 410, when user device 410 no longer requires the desktop, the desktop can be assigned to a different user. The different user can use the same applications or management service 422 can attach different applications to support a different user type.

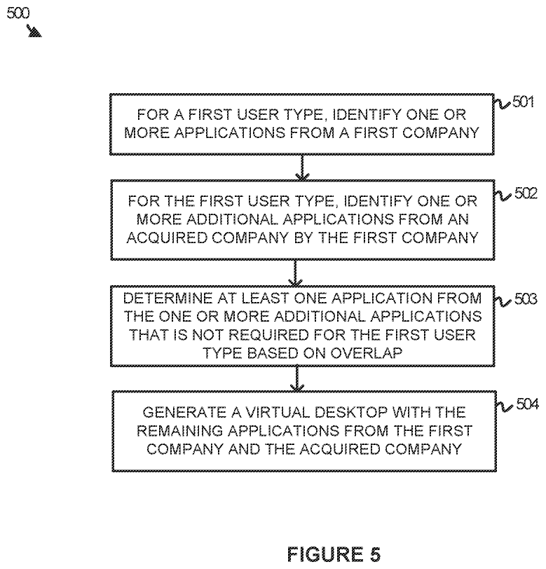

FIG. 5 illustrates an operation 500 of a management service to manage application allocations to acquired personnel according to an implementation. The steps of operation 500 are referenced parenthetically in the paragraphs that follow with reference to systems and elements of computing environment 400. Operation 500 can be performed by management service 422 of FIG. 4 in some examples.

Operation 500 includes, for a first user type, identifying (501) one or more applications from a first company and identifying (502) one or more additional applications from an acquired company by the first company. In some implementations, the management service identifies the applications from one or more databases associated with each of the companies. In some examples, the management service receives input from a user or administrator indicating the applications for the user type.

Operation 500 further determines (503) at least one application from the one or more applications that is not required for the first user type based on overlapping application types. Once determined, the management service prevents the at least one application from being available as part of a virtual desktop. Operation 500 also generates (504) a virtual desktop with the remaining applications from the first company and the acquired company.

As an illustrative example, management service 422 identifies a first user type and identifies applications required by the user at the acquiring company. Additionally, management service 422 identifies one or more additional applications that were available to the first user type at the acquired company. Management service 422 determines overlap between the applications of the acquiring company and the one or more additional applications from the acquired company. For overlapping applications, management service 422 selects the application of the acquiring company over the application of the acquired company. Thus, if the acquired company used a first email application and the acquiring company uses a second email application, the second email application is selected by management service 422 for the first user type. Once the applications are selected from the acquired and the acquiring companies, management service 422 can generate a user desktop of user desktops 430-432 to support the operations of the users.

In at least one implementation, when a request is received from user device 410 and remote application 440, management service 422 identifies a desktop to support the request and establishes a connection between user desktop 430 and user device 410. User desktop 430 is a virtual desktop that allows users to access and control a computer desktop environment remotely over a network connection. In some examples, each user is assigned a unique virtual machine with applications installed that correspond to the user type. Accordingly, a user of a first type will be assigned a virtual machine with first applications installed and a user of a second type will be assigned a virtual machine with second applications installed. In another example, management service 422 dynamically attaches volumes to a base virtual machine, wherein the volumes are mounted with required applications and data associated with the user type. Advantageously, management service 422 uses the same virtual machine for different user types and dynamically attaches the required volumes to the virtual machine based on the user type generating the request.

In some implementations, in addition to filtering applications based on duplicate application types, management service 422 selects and filters the applications for the user type based on available licenses for applications, preferences of administrators associated with the acquiring company, or some other information. For example, management service 422 receives information for available software distributions that are permitted by the acquiring company. From the information, one or more of the applications from the acquired company can be removed, preventing the applications from being available to the employees.

In some examples, management service 422 dynamically changes the applications that are available to the different user types. Specifically, while a first set of applications are made available to a user type during a first period, management service 422 can sunset or remove applications for the user. For example, while a first work processing application is available during a first period, the application can be removed, and another application (associated with the acquiring company) can be added to the application list for the user. Thus, based on preferences of the acquiring company, the applications can be updated for the different user types.

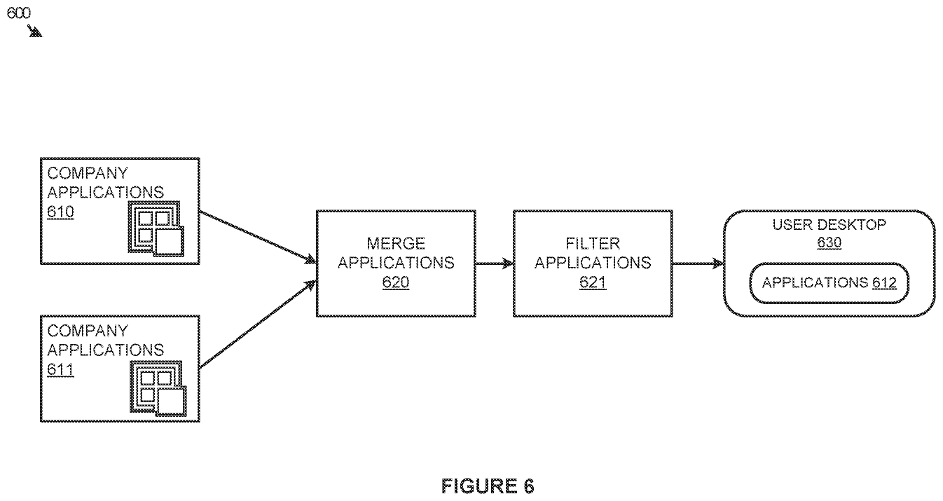

FIG. 6 illustrates an operational scenario 600 of defining applications for a user group according to an implementation. Operational scenario 600 includes company applications 610-611, merge applications 620, filter applications 621, and user desktop 630 with applications 612. Merge applications 620 and filter applications 621 are representative of operations that can be performed by a management service, such as management service 422 of FIG. 4.

In operational scenario 600, merge applications 620 obtains identifiers for company applications 610-611, wherein company applications 610 comprises applications associated with an acquired company and company applications 611 comprises applications associated with the acquiring company. Company applications 610-611 comprise applications associated with a particular user type (e.g., engineering, legal, etc.). After the applications are identified, merge applications 620 merges the applications and removes any duplicate applications. For example, the acquiring company may use a different email application than the acquired company. Accordingly, merge applications 620 will remove the email application from the acquired company list.

After the applications are merged, filter applications 621 filters the applications based on the preferences of the acquiring company. In some examples, the preferences include application vendors, application types, security requirements, or some other requirements in association with the applications. Any applications that fail to satisfy the requirements of the acquiring company are removed, while any applications that remain are made available as applications 612 on user desktop 630. User desktop 630 is representative of a virtual desktop accessible to a user of the user type for company applications 610-611. In some examples, the applications identified via the merge and filter operations are installed on a virtual machine that is made accessible to the user. In other examples, the applications can be attached to a base virtual machine, permitting the applications to become executable on the virtual machine as needed. Thus, when a user requests the desktop, a management service attaches the required volumes for the applications and any additional data and makes the virtual machine accessible over the internet.

Although demonstrated using a single user type, such as engineering, similar operations are performed for the different user types in the acquiring company. Each of the user groups correspond to a different set of applications and are provided to the user based on the credentials associated with the user. Thus, while a first user of a first user type is provided with a first set of applications, a second user of a second user type is provided with a second set of applications.

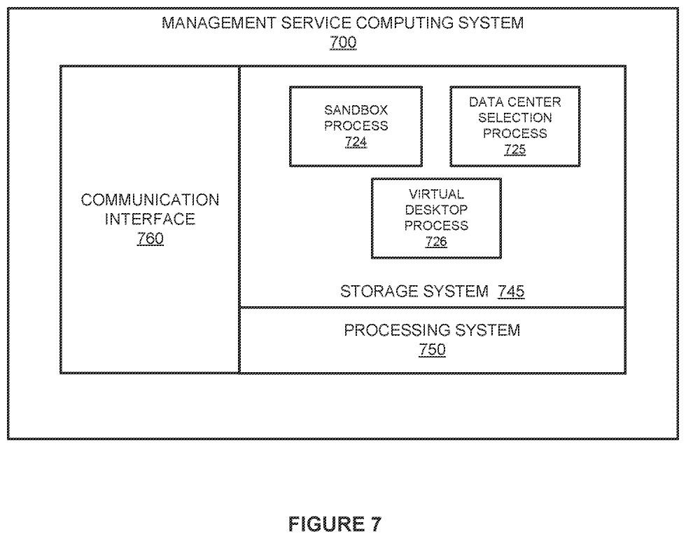

FIG. 7 illustrates a computing system 700 to manage resources associated with a merger or acquisition according to an implementation. Management computing system 700 is representative of any computing system or systems with which the various operational architectures, processes, scenarios, and sequences disclosed herein for a management service can be implemented. Management computing system 700 is an example of management service 110 of FIG. 1 and management service 422 of FIG. 4, although other examples may exist.

Management computing system 700 includes storage system 745, processing system 750, and communication interface 760. Processing system 750 is operatively linked to communication interface 760 and storage system 745. Communication interface 760 may be communicatively linked to storage system 745 in some implementations. Management computing system 700 may further include other components such as a battery and enclosure that are not shown for clarity.

Communication interface 760 comprises components that communicate over communication links, such as network cards, ports, radio frequency (RF), processing circuitry and software, or some other communication devices. Communication interface 760 may be configured to communicate over metallic, wireless, or optical links. Communication interface 760 may be configured to use Time Division Multiplex (TDM), Internet Protocol (IP), Ethernet, optical networking, wireless protocols, communication signaling, or some other communication format-including combinations thereof. Communication interface 760 may be configured to communicate with hosts of a computing environment, administrative or console devices, or some other computing device.

Processing system 750 comprises microprocessor (i.e., at least one processor) and other circuitry that retrieves and executes operating software from storage system 745. Storage system 745 may include volatile and nonvolatile, removable, and non-removable media implemented in any method or technology for storage of information, such as computer readable instructions, data structures, program modules, or other data. Storage system 745 may be implemented as a single storage device but may also be implemented across multiple storage devices or sub-systems. Storage system 745 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no case is the storage media a propagated signal.

Processing system 750 is typically mounted on a circuit board that may also hold the storage system. The operating software of storage system 745 comprises computer programs, firmware, or some other form of machine-readable program instructions. The operating software of storage system 745 includes sandbox process 724, data center selection process 725, and virtual desktop process 726. The operating software on storage system 745 may further include an operating system, utilities, drivers, network interfaces, applications, or some other type of software. When read and executed by processing system 750 the operating software on storage system 745 directs management computing system 700 to operate as a management service described herein in FIGS. 1-6.

In at least one implementation, sandbox process 724 directs processing system 750 to migrate one or more applications from one or more first data centers associated with a first company to one or more second data centers associated with a second company. Computing system 750 initiates the migration following a request from the acquiring company. The migration can include migrating applications (e.g., virtual machines, containers, and the like) and any corresponding data or database to a temporary or sandboxed computing environment supported by the acquiring company. The computing environment may maintain security requirements and certifications required by the acquiring company, permitting the acquiring company to monitor the applications and data prior to finalizing an end processing destination.

Once migrated, data center selection process directs processing system 750 to monitor at least resource usage associated with the one or more applications in the one or more second data centers. The resource usage can correspond to any physical resource usage of the applications in the temporary environment. In some implementations, data center selection process 725 further monitors application or database preferences associated with the acquiring company. The preferences can include vendor preferences for applications, version preferences for applications or databases, or some other preferences. In some implementations, data center selection process 725 further monitors power and resource usage preferences for the applications and database, wherein the preferences indicate whether power usage should be preferred of processor usage, whether data center consolidation should be preferred over data access times or processing resource availability to the applications.

Data center selection process 725 further determines a configuration for the one or more applications based on the resource usage (and any available preferences) associated with the one or more applications and applies the configuration, wherein the configuration defines at least execution locations in a set of data centers for the second company. In some examples, the configuration will indicate applications or databases that require a change from a first version to a second version based on preferences, applications or databases that do not satisfy the preferences and can be terminated rather than migrated to a new location, databases that can be merged into other databases based on the preferences, or some other configuration for migrating the virtual machines. In selecting the location for the applications and databases, data center selection process 725 identifies the data centers with the physical resources to support the applications and databases. Additionally, to save power or physical resources, data center selection process 725 will target consolidating the applications and databases to a fewer number of databases, permitting servers or entire databases to be powered down. In some examples, data center selection process 725 further attempts to migrate the applications and databases to the machines and data centers with the least amount of resource cost (i.e., operational monetary cost) while still maintaining the operational state for the applications and databases.

In some implementations, in addition to or in place of the operations described above, a virtual desktop process 726 directs processing system 750 to generate virtual or remote desktops for new users from an acquired company as the user join the acquiring company. Specifically, virtual desktop process 726 directs processing system 750 to, for each user type, identify applications previously available at the acquired company and applications required by the acquiring company. Virtual desktop process 726 then filters one or more applications from the applications previously available at the acquired company and applications required by the acquiring company based on duplicated application types, application limitations at the acquiring company, or some other factor. In one example, if two email applications are identified, then only the application for the acquiring company will be selected and the other will not be made available on the virtual desktop. In another example, if an application is from a vendor that is not permitted by the acquiring company, then the application will not be made available at the virtual desktop.

After filtering or removing the one or more applications, virtual desktop process 726 directs processing system 750 to make a virtual desktop available in a data center for a user of the first user type. In one implementation, when a user generates a request for a virtual desktop, virtual desktop process 726 will identify the user type associated with the request and provide a connection to a virtual machine or virtual desktop associated with the user type. In some examples, the virtual machine permanently installs the applications required by the user. In another example, virtual desktop process 726 identifies a base image of a virtual machine and attaches the required applications to the virtual machine by mounting storage volumes that contain the application data and other data required by the user.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method comprising:
migrating one or more applications from one or more first data centers associated with a first company to one or more second data centers associated with a second company;
monitoring resource usage associated with the one or more applications in the one or more second data centers;
determining a configuration for the one or more applications based on the resource usage associated with the one or more applications; and
applying the configuration, wherein the configuration defines at least execution locations in a set of data centers for the second company.

2. The method of claim 1, wherein the resource usage comprises at least processor usage requirements and memory usage requirements.

3. The method of claim 1 further comprising:
identifying application preferences associated with the second company, wherein the application preferences comprise application vendors, application types, or application versions; and
wherein determining the configuration for the one or more applications is further based on the application preferences.

4. The method of claim 3, wherein the configuration terminates at least one application of the one or more applications based on the resource usage.

5. The method of claim 3, wherein the configuration comprises updates for at least one application of the one or more applications.

6. The method of claim 1 further comprising:
obtaining power target goals in association with the one or more applications; and
wherein determining the configuration for the one or more applications is further based on the power target goals.

7. The method of claim 1 further comprising:
migrating one or more databases from the one or more first data centers associated with the first company to the one or more second data centers associated with the second company;
identifying database requirements associated with the one or more databases in the one or more second data centers, wherein the database requirements comprise storage requirements and database version requirements;
determining a database configuration for the one or more databases based on the database requirements; and
applying the database configuration, wherein the database configuration defines at least storage locations for the one or more databases in a set of data centers for the second company.

8. The method of claim 7, wherein the database configuration further modifies a version of at least one database of the one or more databases from a first version to a second version.

9. The method of claim 7, wherein the database configuration further integrates at least one database of the one or more databases with a second database of the second company.

10. The method of claim 1, wherein the one or more second data centers comprise at least one data center that is different than the set of data centers.

11. An apparatus comprising:
one or more non-transitory computer readable storage media;
program instructions stored on the one or more non-transitory computer readable storage media that, when executed by at least one processor, direct the at least one processor to:
migrate one or more applications from one or more first data centers associated with a first company to one or more second data centers associated with a second company;
monitor resource usage associated with the one or more applications in the one or more second data centers;
determine a configuration for the one or more applications based on the resource usage associated with the one or more applications; and
apply the configuration, wherein the configuration defines at least execution locations in a set of data centers for the second company.

12. The apparatus of claim 11, wherein the resource usage comprises at least processor usage requirements and memory usage requirements.

13. The apparatus of claim 11, wherein the program instructions further direct the at least one processor to:
identify application preferences associated with the second company, wherein the application preferences comprise application vendors, application types, or application versions; and
wherein determining the configuration for the one or more applications is further based on the application preferences.

14. The apparatus of claim 13, wherein the configuration terminates at least one application of the one or more applications based on the resource usage.

15. The apparatus of claim 13, wherein the configuration comprises updates for at least one application of the one or more applications.

16. The apparatus of claim 11, wherein the program instructions further direct the at least one processor to:
obtain power target goals in association with the one or more applications; and
wherein determining the configuration for the one or more applications is further based on the power target goals.

17. The apparatus of claim 11, wherein the program instructions further direct the at least one processor to:
migrate one or more databases from the one or more first data centers associated with the first company to the one or more second data centers associated with the second company;
identify database requirements associated with the one or more databases in the one or more second data centers, wherein the database requirements comprise storage requirements and database version requirements;
determine a database configuration for the one or more databases based on the database requirements; and
apply the database configuration, wherein the database configuration defines at least storage locations for the one or more databases in a set of data centers for the second company.

18. The apparatus of claim 17, wherein the database configuration further modifies a version of at least one database of the one or more databases from a first version to a second version.

19. The apparatus of claim 17, wherein the database configuration further integrates at least one database of the one or more databases with a second database of the second company.

20. A computing apparatus comprising:
one or more non-transitory computer readable storage media;
a processing system operatively coupled to the one or more non-transitory computer readable storage media; and
program instructions stored on the one or more non-transitory computer readable storage media that, when executed by the processing system, direct the processing system to:
migrate one or more applications from one or more first data centers associated with a first company to one or more second data centers associated with a second company;
monitor resource usage associated with the one or more applications in the one or more second data centers;
determine a configuration for the one or more applications based on the resource usage associated with the one or more applications; and
apply the configuration, wherein the configuration defines at least execution locations in a set of data centers for the second company.
